(19) United States
(12) Patent Application Publication
(10) Pub. No.: US 2002/0143569 A1
(43) Pub. Date: Oct. 3, 2002

(54) System and method for rendering legal services over the internet

(75) Inventor: Richard S. Draughon, Ponte Vedra Beach, FL (US)

Correspondence Address: Jeffrey C. Maynard, Draughon Professional Association, Suite 2000, One Independent Drive, Jacksonville, FL, 32202-5015, US

(73) Assignee: Seti Corporation d/b/a Draughon, Jacksonville, FL (US)

(21) Appl. No.: 10/059,452

(22) Filed: Jan. 29, 2002

Related U.S. Application Data
(63) Continuation-in-part of application No. 09/820,031, filed on Mar. 28, 2001.

(51) Int. Cl. G06F 17/60

(52) U.S. Cl. 705/1

(57) ABSTRACT

A method and system for rendering legal services on-line using a hierarchical arrangement of sections, libraries, sub-libraries and legal forms; streaming instructional videos concerning the sections, libraries, sub-libraries and legal forms; and commentary concerning the sections, libraries, sub-libraries and legal forms; are disclosed. A program whereby attorneys can become affiliates and reap additional benefits to build a technology law practice is also disclosed. A membership program in which organizations can promote their event and obtain discounted services is also disclosed. In a preferred embodiment, the disclosed method and system employs an on-line system for purchasing subscriptions and advertising services.

### RELATED APPLICATION

Related Application

This application is a continuation-in-part of: copending and co-owned U.S. patent application Ser. No. 09/820,031 entitled System and Method for Rendering Legal Services Over the Internet, filed with the U.S. Patent and Trademark Office on Mar. 28, 2001.

### BACKGROUND OF THE INVENTION

1. FIELD OF THE INVENTION

This invention relates to a system and method for rendering legal services on-line, preferably over the Internet.

2. BACKGROUND OF THE INVENTION

Entrepreneurs and businesses require legal services to manage their legal affairs, the cost of which can be staggering. While large corporations can afford extensive legal representation and manage in-house or outside counsel, individuals and small businesses, including start-ups, often do not have a significant budget for legal services. Consequently, some of their legal work may simply go undone, or be handled by uninitiated members of their staff, substantially increasing the entity's risk profile and potentially compromising the entity's rights.

Budgetary limitations are not the only impediment to obtaining legal representation for small businesses and entrepreneurs. Based upon prevailing societal prejudices, many people are wary of lawyers. Some have grown distrustful of attorneys, having had unpleasant and costly past experiences. They would prefer to manage their own legal affairs, but, until now, lacked the resources to do so.

Even trade organizations and associations need legal services. Individual members of such organizations and associations, particularly those involved in technology transactions can benefit from fast, low cost, pre-formatted legal forms and access to inexpensive legal consultation.

Junior lawyers at law firms and corporations require similar resources for managing legal affairs. They need significant guidance and training to operate effectively. Senior attorneys often prefer to focus on billable activities, rather than provide the junior attorney the necessary structured guidance and training. While large organizations can afford to devote staff to provide orientation and tutorials, many small organizations cannot afford to do the same. In such situations, both the organization and junior attorney suffer. Failing to provide the necessary guidance and training substantially compromises the junior attorney's chances of operating effectively.

Independent lawyers entering the field of technology law and desiring to establish a technology law practice in their local community may find it difficult to build a technology client base and promote their expertise. With little infrastructure support, such lawyers usually fail to seek out and exploit opportunities for professional growth, such as publishing scholarly articles or taking advantage of mentoring occasions. Moreover, independent lawyers may not have the financial resources to promote their practice using conventional methods, such as Internet websites and directory listings.

While do-it-yourself books, software and forms libraries have emerged to capitalize on the need for low-cost self-help legal solutions, these tools typically do not provide sufficient information and guidance as well as a structured framework needed for the uninitiated to intelligently select the best legal form as a starting point, understand its application and correctly complete it. Many such tools offer forms tailored in favor of only one side of a transaction (e.g., buyer), or not tailored in favor of either side, potentially compromising the legal interests of the user. Geared for experienced lawyers, many such tools skip introductory materials and use arcane legal jargon, making them incomprehensible to the layperson and inexperienced attorney.

Professional organizations attempt to provide assistance and guidance for lawyers of all experience levels. Unfortunately, for lawyers venturing into a new practice area, the time spent with such organization takes away from time for billable activities.

Until now, there existed an unfulfilled need for a system, such as that provided through Applicant's MyTechnologyLawyer website at www.mytechnologylawyer.com, comprised of on-line interactive resources for managing legal affairs. In addition to resources to help entrepreneurs, executives, their lawyers and junior attorneys to independently prepare necessary agreements, negotiate transactions, obtain focused legal consultations, evaluate disputes, resolve disputes and, if necessary, retain legal counsel, independent lawyers can become affiliates of an established law practice. Such affiliates can use resources such as that provided through Applicant's MyTechnologyLawyer website at www.mytechnologylawyer.com to build their own technology law practice.

Trade organizations and associations can use the resources such as that provided through Applicant's MyTechnologyLawyer website at www.mytechnologylawyer.com to obtain promotional exposure and offer members discounted services with a rebate paid directly to the organization.

### SUMMARY OF THE INVENTION

The present invention provides a system and method for providing on-line interactive resources for managing legal affairs. The system includes legal forms and dispute resolution, case review, consultation tools, as well as legal resources, lawyer locator and media exposure services. It also includes administrative tools to manage and enhance the system.

An object of the invention is to provide a collection of forms for businesses and individuals to use for managing their legal affairs.

Another object of the invention is to provide tools for alternative dispute resolution.

Another object of the invention is to provide tools for direct lawyer consultations.

Another object of the invention is to enable rapid access to legal resources and information.

Another object of the invention is to provide a template for an attorney to subscribe to an Affiliate program. A related object of the invention is to enable such Affiliate attorney to create a personal website within the system of the subject invention. A further related object of the invention is to enable publication opportunities for such Affiliate attorney within the system of the subject invention. Yet another related object is to enable peer collaboration for such Affiliate attorney within the system of the subject invention.

Another object of the invention is to enable full service promotion of clients and legal issues facing such client by a wide variety of media exposure. A related object of the invention is to enable organizations and associations to become members having unique discounted purchasing opportunities. A further related object is to provide such member focused promotion opportunities.

Another object of the invention is to provide administrative tools for managing the system of the subject invention.

Still another object of the invention is to provide tools for managing client account information.

An additional object of the invention is to provide a system map.

The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 depicts an introduction (Home) section of a system in accordance with an embodiment of the subject invention;

FIG. 2 depicts a legal forms section page of a system in accordance with an embodiment of the subject invention;

FIG. 3 depicts a first subscription purchasing page of a system in accordance with an embodiment of the subject invention;

FIG. 4 depicts a second subscription purchasing page of a system in accordance with an embodiment of the subject invention;

FIG. 5 depicts a purchase agreement page of a system in accordance with an embodiment of the subject invention;

FIG. 6 depicts a third subscription purchasing page of a system in accordance with an embodiment of the subject invention;

FIG. 7 depicts a fourth subscription purchasing page of a system in accordance with an embodiment of the subject invention;

FIG. 8 depicts a User Login page of a system in accordance with an embodiment of the subject invention;

FIG. 9 depicts an Affiliate information page of a system in accordance with an embodiment of the subject invention;

FIG. 10 depicts a Summary of Benefits page of a system in accordance with an embodiment of the subject invention;

FIG. 11 depicts a first benefits page of a system in accordance with an embodiment of the subject invention;

FIG. 12 depicts a second benefits page of a system in accordance with an embodiment of the subject invention;

FIG. 13 depicts a third benefits page of a system in accordance with an embodiment of the subject invention;

FIG. 14 depicts a fourth benefits page of a system in accordance with an embodiment of the subject invention;

FIG. 15 depicts a fifth benefits page of a system in accordance with an embodiment of the subject invention;

FIG. 16 depicts a sixth benefits page of a system in accordance with an embodiment of the subject invention;

FIG. 17 depicts a seventh benefits page of a system in accordance with an embodiment of the subject invention;

FIG. 18 depicts an eighth benefits page of a system in accordance with an embodiment of the subject invention;

FIG. 19 depicts a ninth benefits page of a system in accordance with an embodiment of the subject invention;

FIG. 20 depicts a fee schedule page of a system in accordance with an embodiment of the subject invention;

FIG. 21 depicts a first Affiliate Application page of a system in accordance with an embodiment of the subject invention;

FIG. 22 depicts a second Affiliate Application page of a system in accordance with an embodiment of the subject invention;

FIG. 23 depicts a third Affiliate Application page of a system in accordance with an embodiment of the subject invention;

FIG. 24 depicts a fourth Affiliate Application page of a system in accordance with an embodiment of the subject invention;

FIG. 25 depicts a fifth Affiliate Application page of a system in accordance with an embodiment of the subject invention;

FIG. 26 depicts a News & Resources section page of a system in accordance with an embodiment of the subject invention;

FIG. 27 depicts an Industry Resources linking page of a system in accordance with an embodiment of the subject invention;

FIG. 28 depicts a Find a Lawyer section page of a system in accordance with an embodiment of the subject invention;

FIG. 29 depicts a specific geographic listing of lawyers in accordance with an embodiment of the subject invention;

FIG. 30 depicts a specific Attorney Profile in accordance with an embodiment of the subject invention;

FIG. 31 depicts a first page of an Affiliate website of a system in accordance with an embodiment of the subject invention;

FIG. 32 depicts a second page of an Affiliate website of a system in accordance with an embodiment of the subject invention;

FIG. 33 depicts a third page of an Affiliate website of a system in accordance with an embodiment of the subject invention;

FIG. 34 depicts a fourth page of an Affiliate website of a system in accordance with an embodiment of the subject invention;

FIG. 35 depicts a fifth page of an Affiliate website of a system in accordance with an embodiment of the subject invention;

FIG. 36 depicts an In The Media section page of a system in accordance with an embodiment of the subject invention;

FIG. 37 depicts a broadcast media page of a system in accordance with an embodiment of the subject invention;

FIG. 38 depicts a print media page of a system in accordance with an embodiment of the subject invention;

FIG. 39 depicts a press interviews page of a system in accordance with an embodiment of the subject invention;

FIG. 40 depicts a speaking engagements page of a system in accordance with an embodiment of the subject invention; and

FIG. 41 depicts a Member Home page of a system in accordance with an embodiment of the subject invention.

### DETAILED DESCRIPTION OF THE INVENTION

The invention summarized above and defined by the enumerated claims may be better understood by referring to the following detailed description, which should be read in conjunction with the accompanying drawings in which like reference numbers are used for like parts. This detailed description of an embodiment, set out below to enable one to build and use an implementation of the invention, is not intended to limit the enumerated claims, but to serve as a particular example thereof. Those skilled in the art should appreciate that they may readily use the conception and specific embodiment disclosed as a basis for modifying or designing other methods and systems for carrying out the same purposes of the present invention. Those skilled in the art should also realize that such equivalent assemblies do not depart from the spirit and scope of the invention in its broadest form.

The term user, as employed herein, means an individual utilizing the system of the subject invention to manage legal affairs. The term subscriber, as employed herein, means a user who may access legal forms on the system. The term template, as employed herein, refers to any means for providing information, including predefined forms having blank spaces for completion by a user.

The system of the present invention is implemented for on-line user access over a computer network, preferably the Internet and particularly the World Wide Web, using prevailing Internet access and browser software, such as Microsoft's Windows operating system and either Netscape Navigator or Microsoft's Internet Explorer browser. The system may also be implemented on local area networks, wide area networks, intranets and computers providing direct dial-up access to users. The system may include HTML, scripts (e.g., JAVA and VB), cgi applications, activeX data objects, applets, database software, databases and the like.

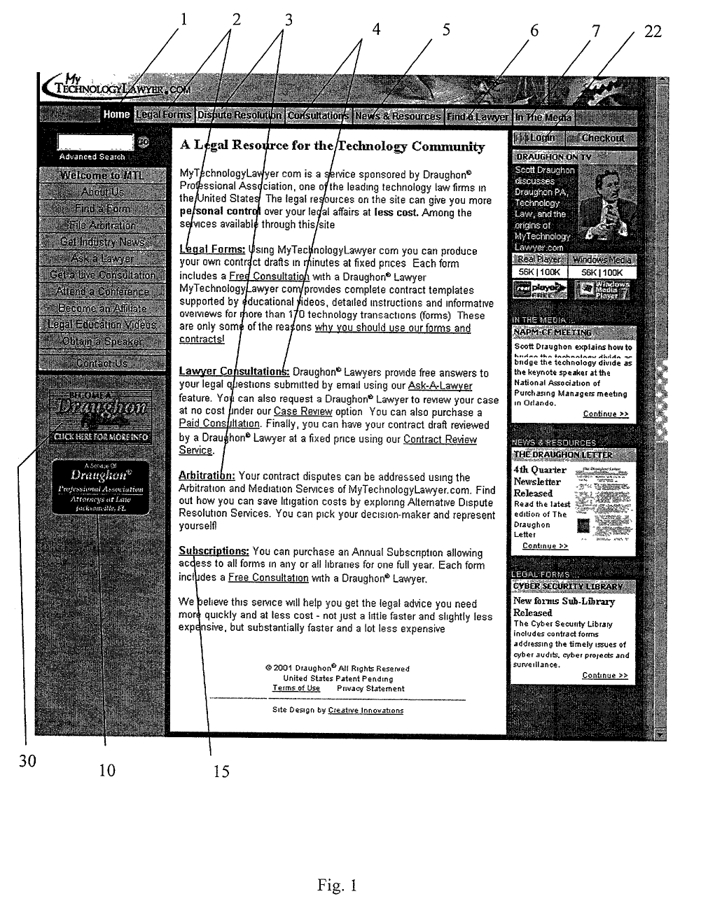

Preferably, the system is divided into discrete intuitive sections to facilitate administration as well as user navigation. For example, referring to FIG. 1, the system may include the following sections: “Home” 1, “Legal Forms” 2, “Dispute Resolution” 3, “Consultations” 4, “New & Resources” 5, “Find a Lawyer” 6, and “In The Media” 7 sections.

The Introduction section, accessed by selecting a “Home” link 1, provides information concerning the sponsor 10 of the system and the scope of coverage, such as “Legal Forms” 2, Arbitration, a form of “Dispute Resolution” 3, and Lawyer Consultations 4. Well-informed users will seek information concerning the professional experience, credentials and any potential biases of the sponsor. A sponsor's expertise will inspire confidence.

The “Legal Forms” section, accessed by selecting a corresponding link 2, provides legal forms covering a wide array of subjects and transactions. Many of the forms favor one party to a transaction over the other party to a transaction. For example, a licensee-oriented software license form would contain broad warranties, whereas a licensor-oriented software license form would contain a very limited warranty and broad warranty disclaimers.

The “Legal Forms” section, described in more detail in co-pending U.S. patent application Ser. No. 09/820,031 entitled System and Method for Rendering Legal Services Over the Internet, incorporated herein by reference in its entirety, includes a hierarchy of libraries and sub-libraries that users may access by selecting corresponding links. The forms are organized in a hierarchy of libraries and sub-libraries to facilitate user navigation. Each library covers a legal topic and provides access to sub-libraries and/or forms. Sub-libraries cover an aspect of the legal topic and provide access to additional sub-libraries or forms. For a narrow legal topic or a legal topic for which there are relatively few forms, libraries may omit sub-libraries and provide access directly to the legal forms.

At each level of the hierarchy, the system preferably provides written information, i.e., commentary, and a video presentation on the selected topic or form. The written commentary and video provide information designed to help a user navigate through the libraries and sub-libraries, select the best form to use as a starting point for a particular transaction, understand the issues involved and learn how to complete the form. The commentary and presentation guide a user by discussing the available libraries and sub-libraries. In a preferred embodiment, the system also includes commentary and a streaming video presentation on each available form. A user may view a video by selecting it using a browser equipped with a compatible streaming video plug-in.

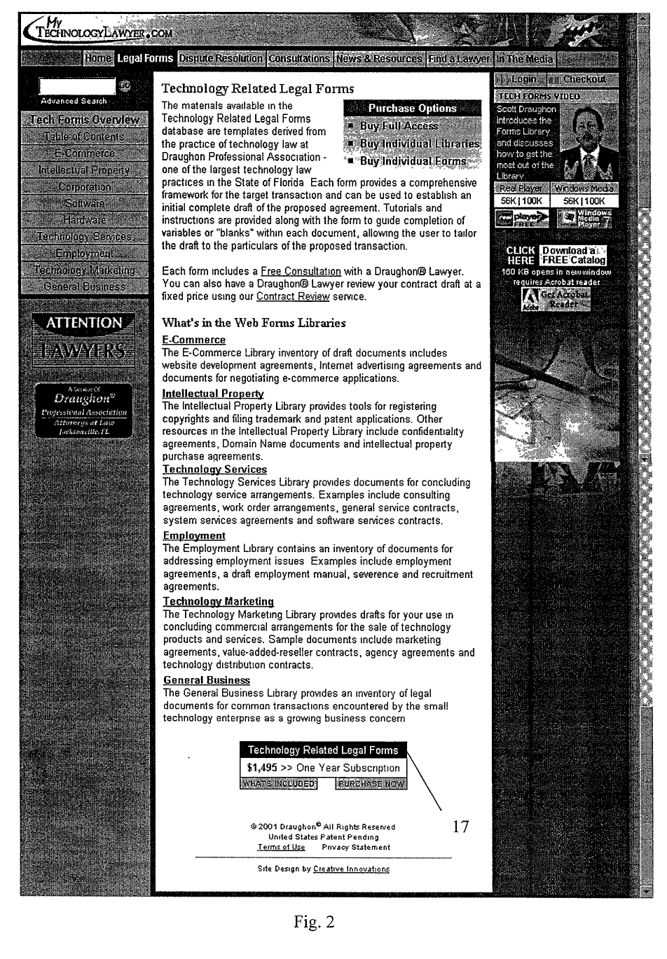

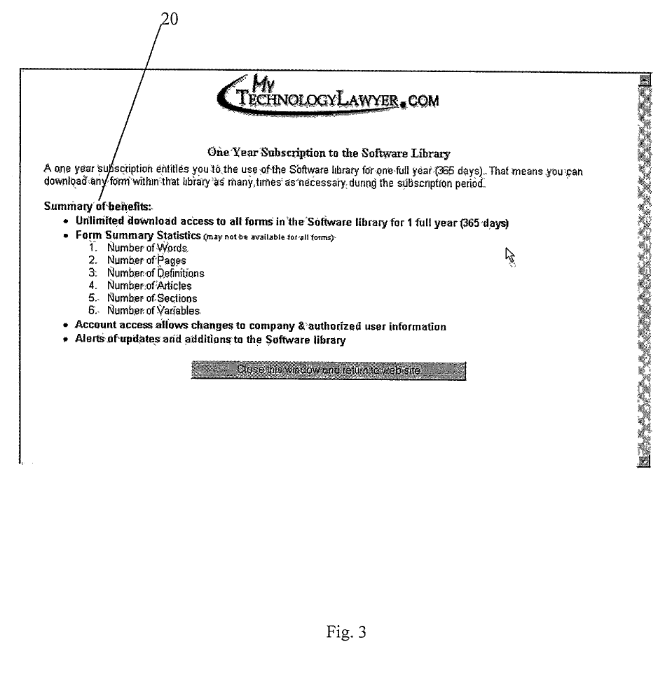

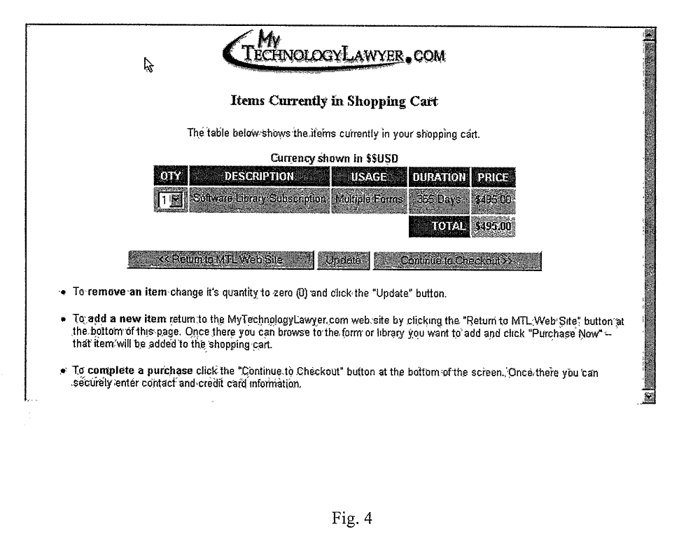

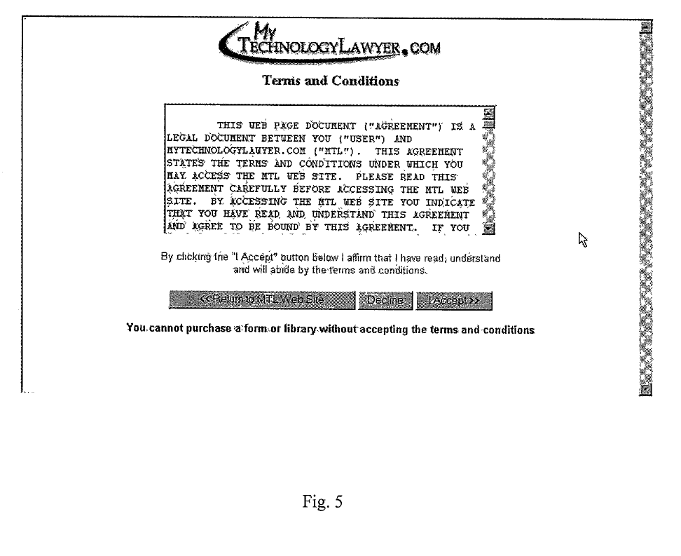

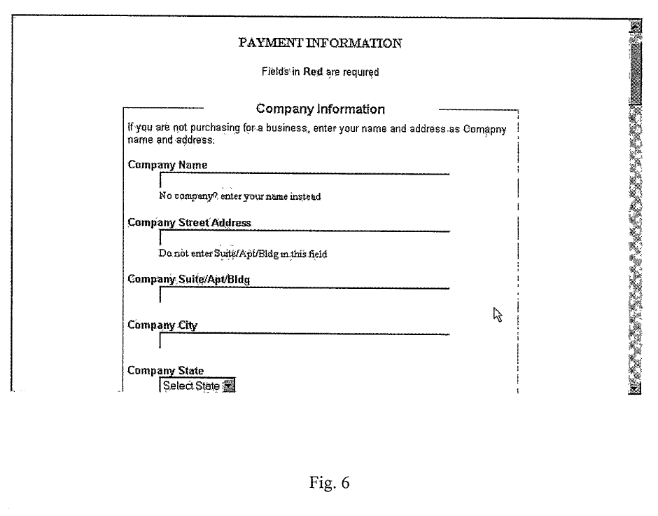

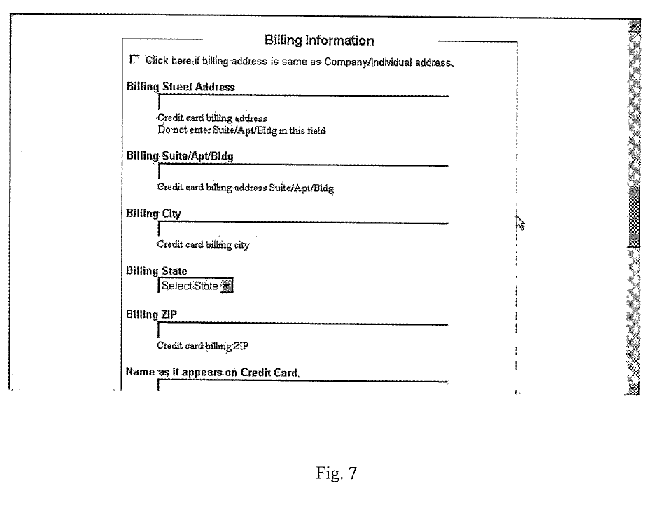

The system provides pricing information and purchasing links at various levels of the hierarchy. By selecting the subscription link 9 on FIG. 1, the user is directed to information concerning Technology Related Legal Forms, FIG. 2 where general information concerning the forms libraries is provided and a link to purchase a subscription is also enabled. For example, at the bottom of the technology related legal forms page, FIG. 2, the system provides pricing information 17 for a subscription to all the libraries listed. Similarly, the system may provide pricing information for a subscription to each individual library and pricing information for an individual form. The system may also provide pricing information for a subscription to each sub-library. The pricing information includes details concerning the benefits 20 of the priced subscription, FIG. 3. A subscription may provide a subscriber access to legal forms for a specified duration, a certain number of times, or some combination. An adjacent link takes a user through a secure on-line purchasing sequence, presenting the user with an on-line shopping cart FIG. 4 and prompting the user for assent to the purchase terms FIG. 5. Templates may be provided to solicit company information FIG. 6, billing information FIG. 7, contact information, and checkout confirmation. Systems designed exclusively for internal use by an organization may omit such pricing information and purchasing links.

Preferably, the system includes revision control for the purchase terms FIG. 5. Each version of the purchase terms and conditions, to which a user must assent to complete a purchase, is assigned a unique identification (“version number”). The system stores at least one copy of that version. Upon the completion of a purchase, the version number is stored along with the purchase information. Should a dispute subsequently arise in connection with the purchase, the system administrator could retrieve the purchase information and version number, and produce an exact copy of the accepted terms and conditions for determining the parties' rights and obligations.

The system preferably offers downloadable forms in a format readily accessible and modifiable by most users, e.g., Rich Text format. Other formats may be used as well, including (without limitation) HTML, MS Word, Corel WordPerfect, ASCII text, Adobe Acrobat (pdf). At a minimum, users will want to electronically fill blanks in the forms. Sophisticated users may wish to amend or modify the language of a form to suit their particular needs.

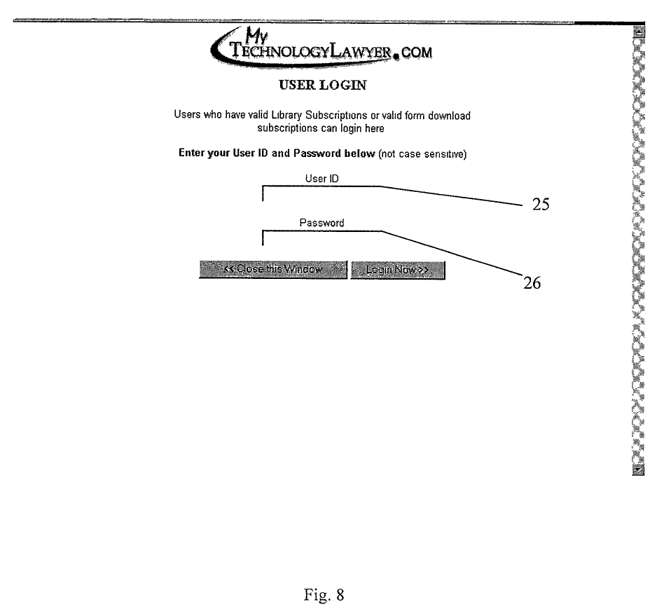

Users that have a subscription for a library or form can login by selecting the LOGIN link 22 (FIG. 1), which will direct them to a User Login page, FIG. 8, wherein a valid user can enter a unique User ID 25 and personal password 26. Such user login facilitates multiple form purchases.

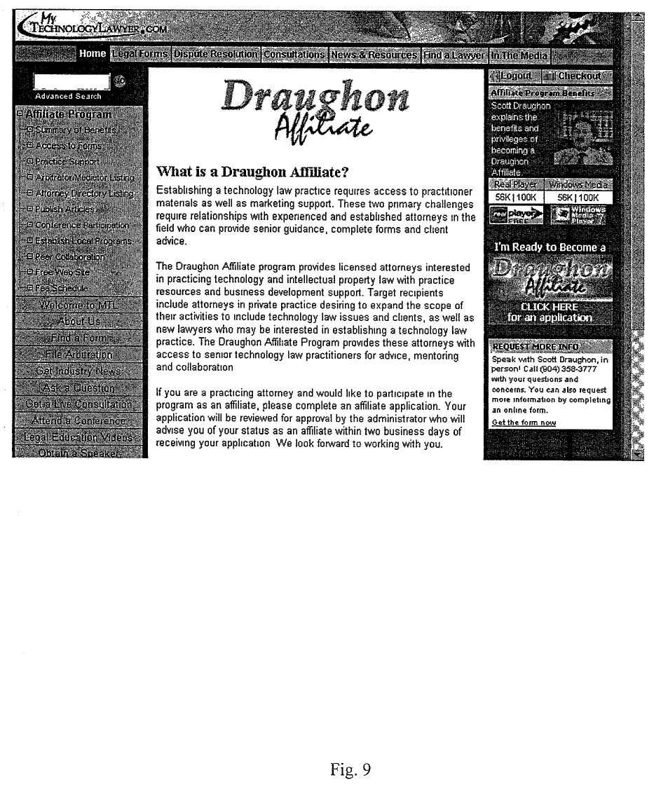

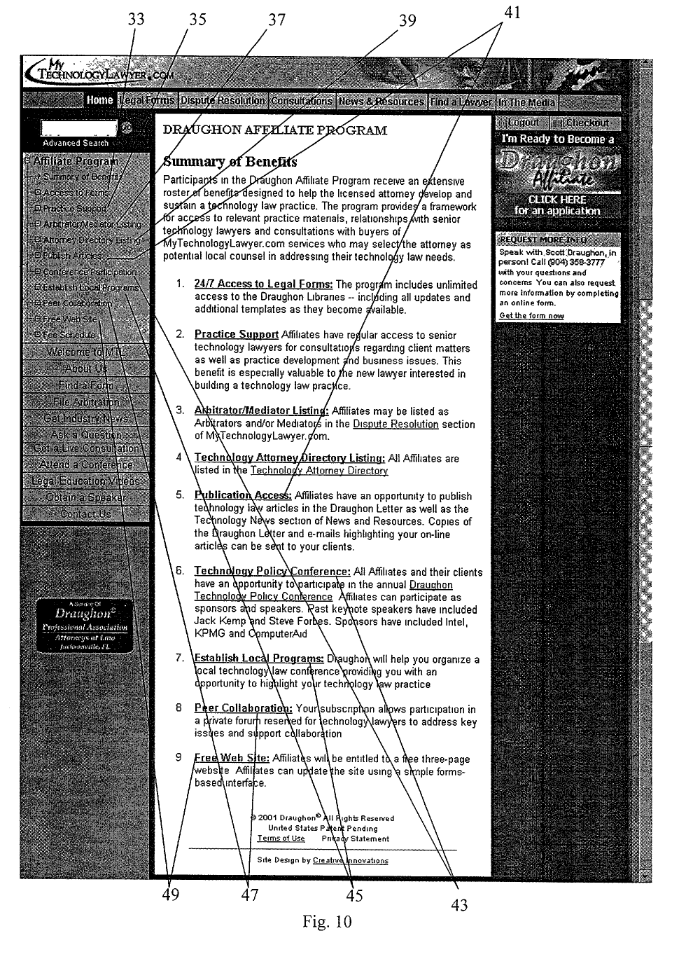

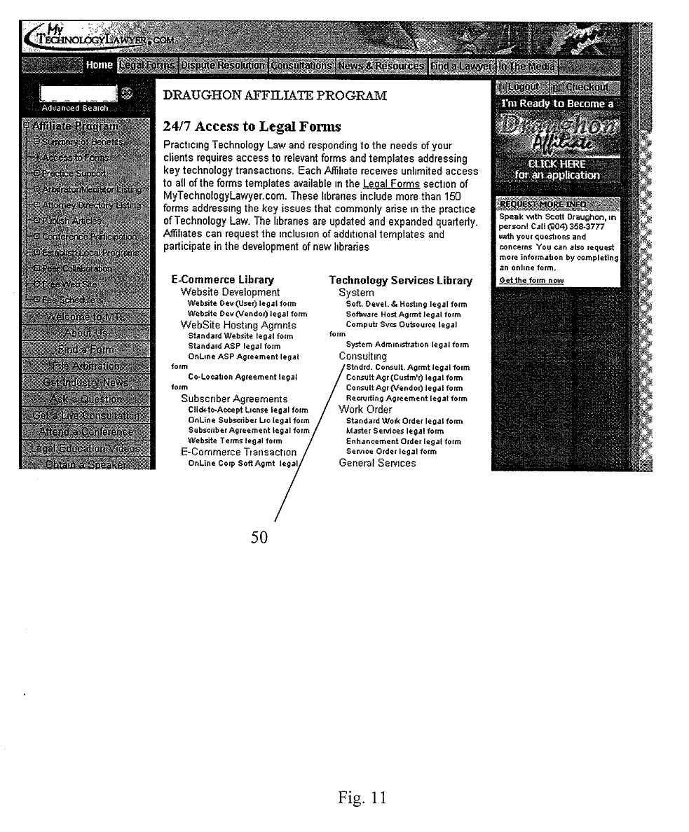

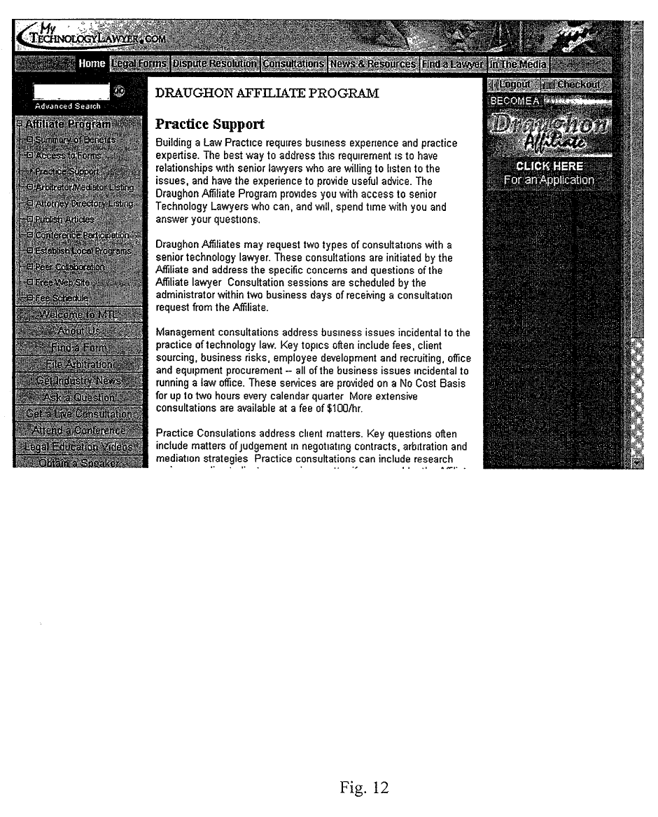

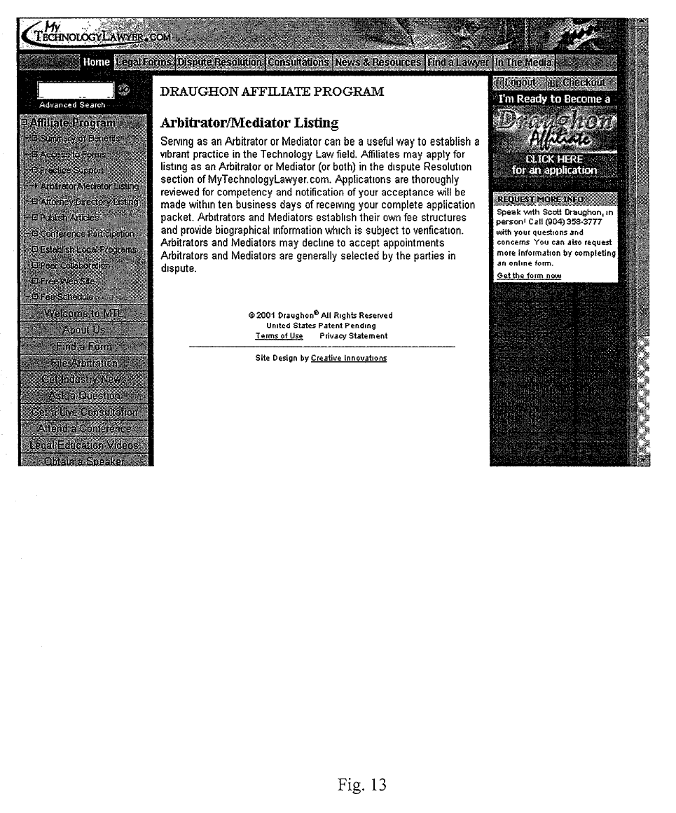

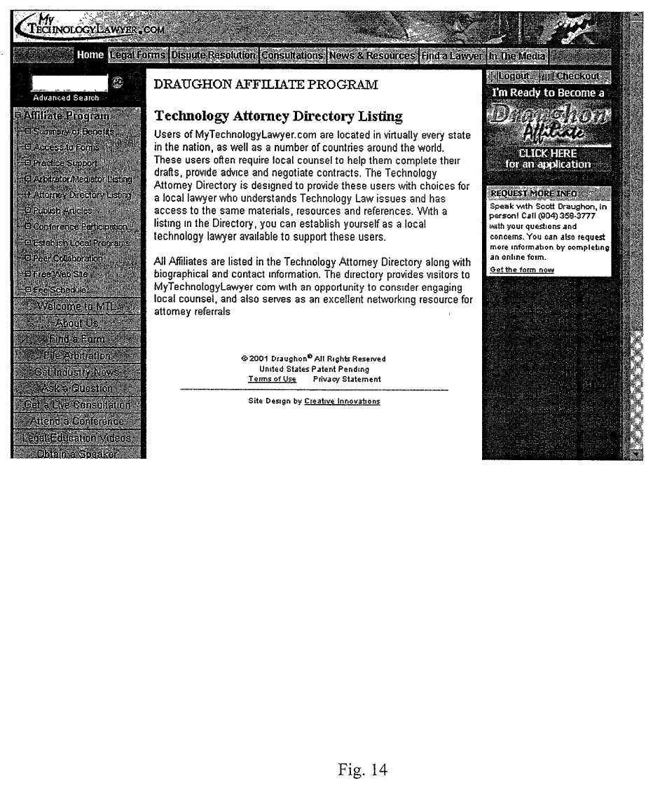

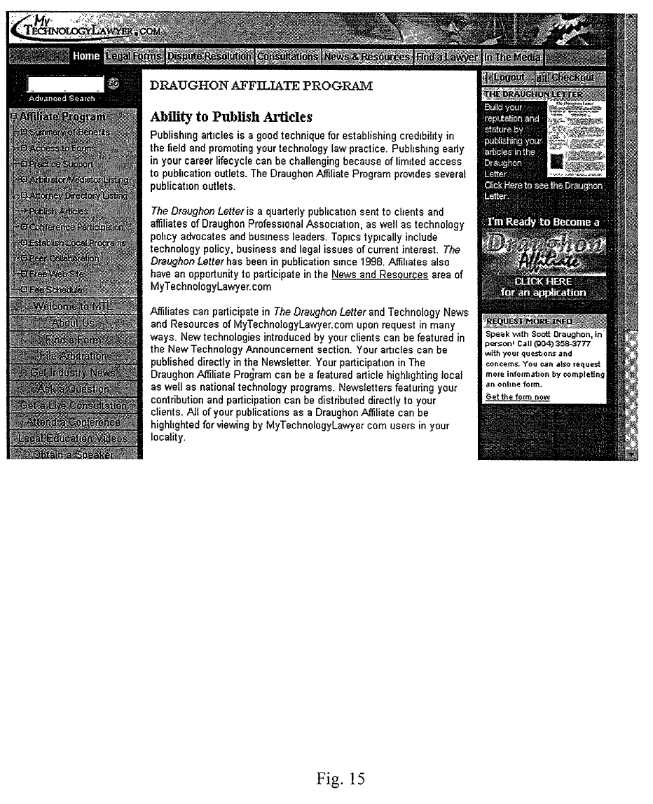

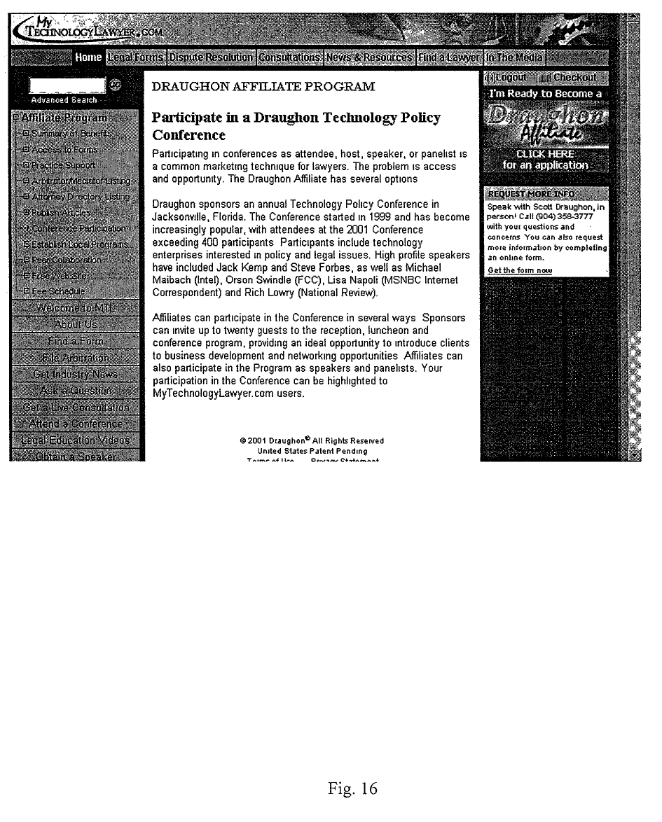

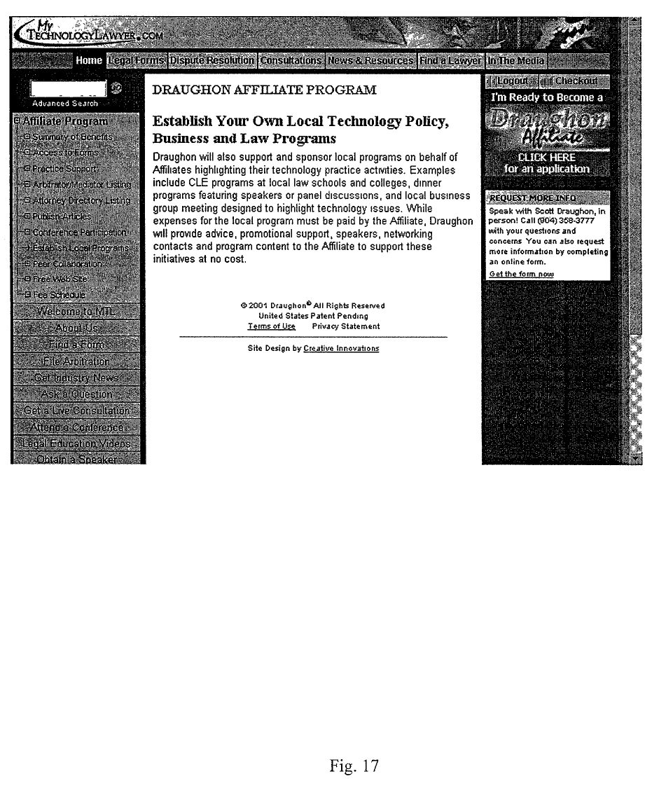

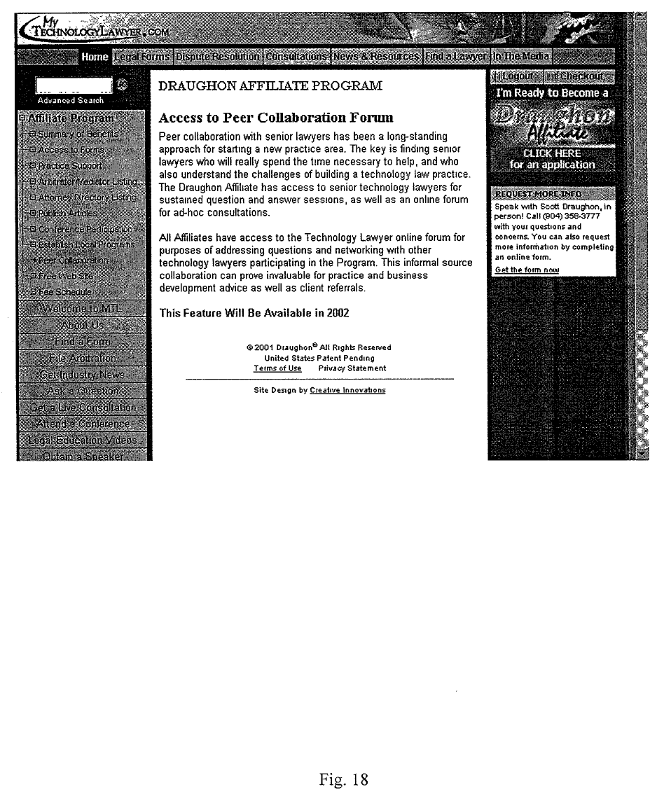

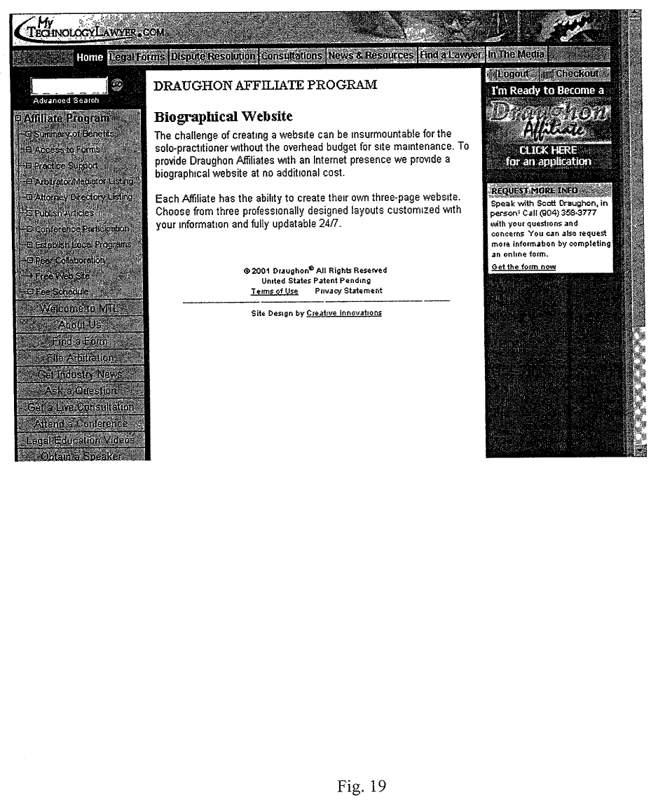

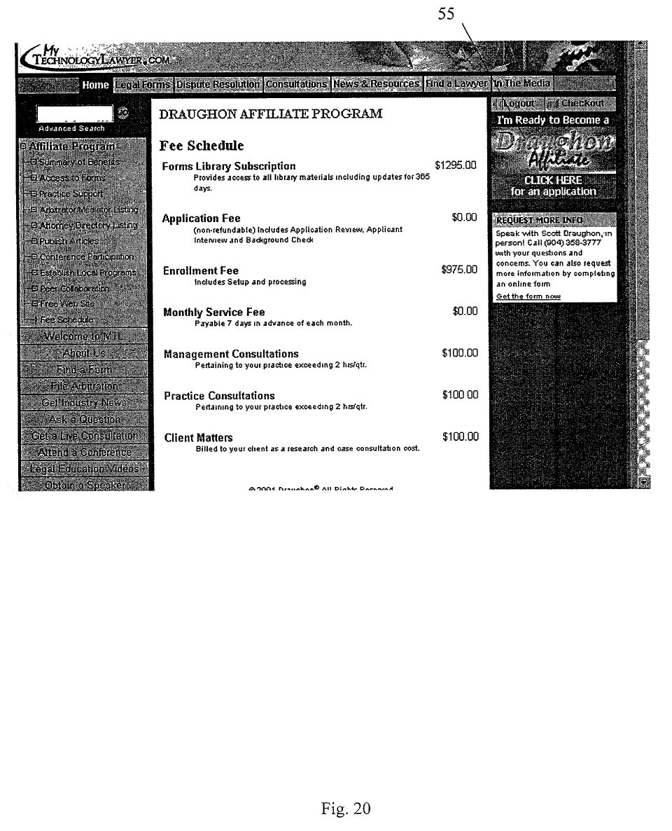

An additional feature enables attorneys to become affiliates and gain additional benefits by using the system. Establishing a technology law practice requires access to practitioner materials as well as marketing support. These two primary challenges require relationships with experienced and established attorneys in the field who can provide senior guidance, complete forms and client advice. By selecting the link to become an affiliate 30 (FIG. 1), the user is directed to an information page, FIG. 9. Follow on links describe the Affiliate Program. Referring to FIG. 10, Benefits of the Affiliate Program are summarized. A graphical hierarchical tree facilitates navigation. Not only does the tree reveal the user's current location, it provides a means for quickly jumping to a new location by selecting the desired tree element. Referring to the top left of FIG. 10, the tree reveals the Affiliate Program related links, such as Access to Forms 33, Practice Support 35, Arbitrator/Mediator Listing 37, Attorney Directory Listing 39, Access to Publish Articles 41, Participation in Technology Policy Conference 43, Assistance in Establishing Local Programs 45, Peer Collaboration 47, and a Personal Website 49. Each of the links can also be reached by its corresponding description on the page. FIGS. 11-19 illustrate the information obtainable by selecting designated links. For example, FIG. 11 shows an explanation of Affiliate access to Legal Forms. The listing of forms also provides a link to each individual form, such as Stndrd. Consult. Agrmt. legal form 50. For attorneys who are interested in joining the Affiliate Program, FIG. 20 illustrates a fee schedule that may be applied for membership services.

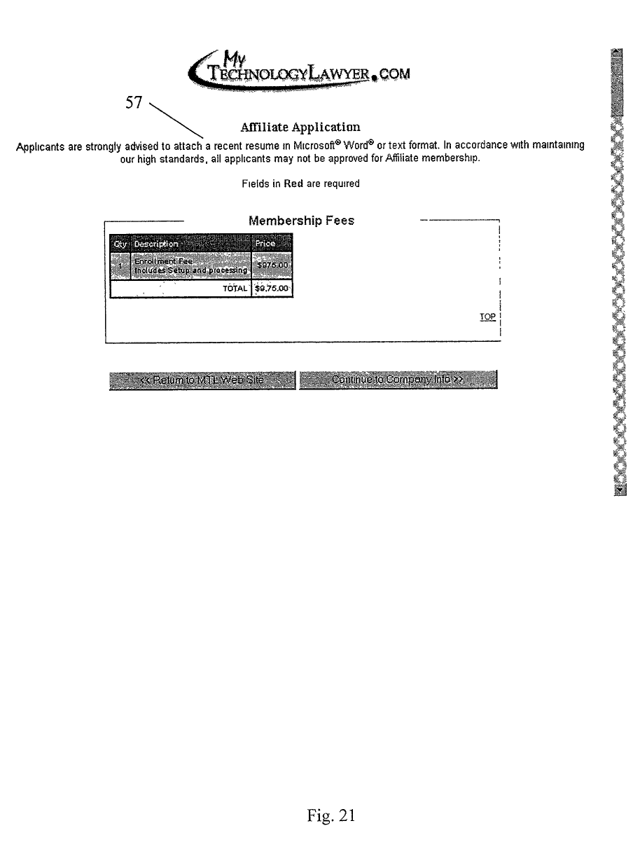

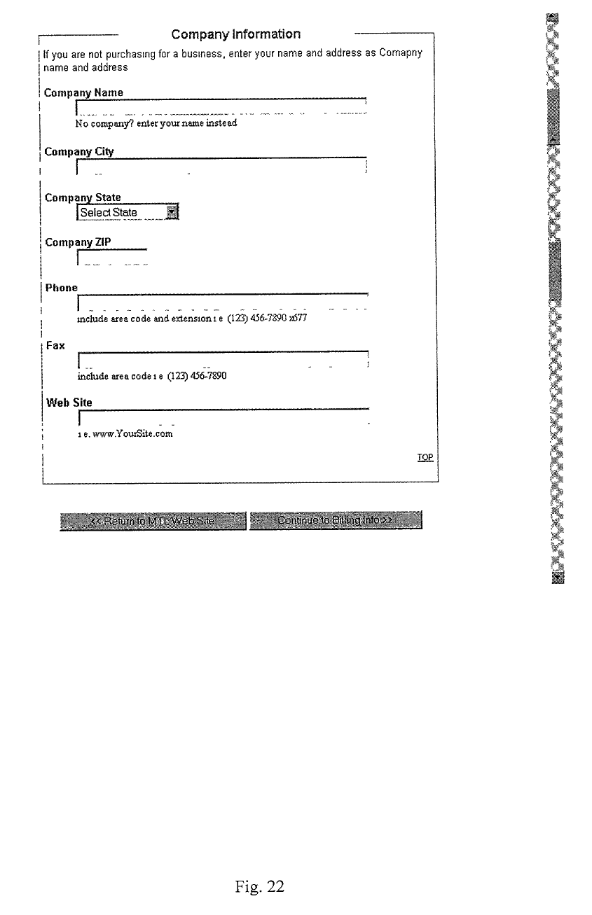

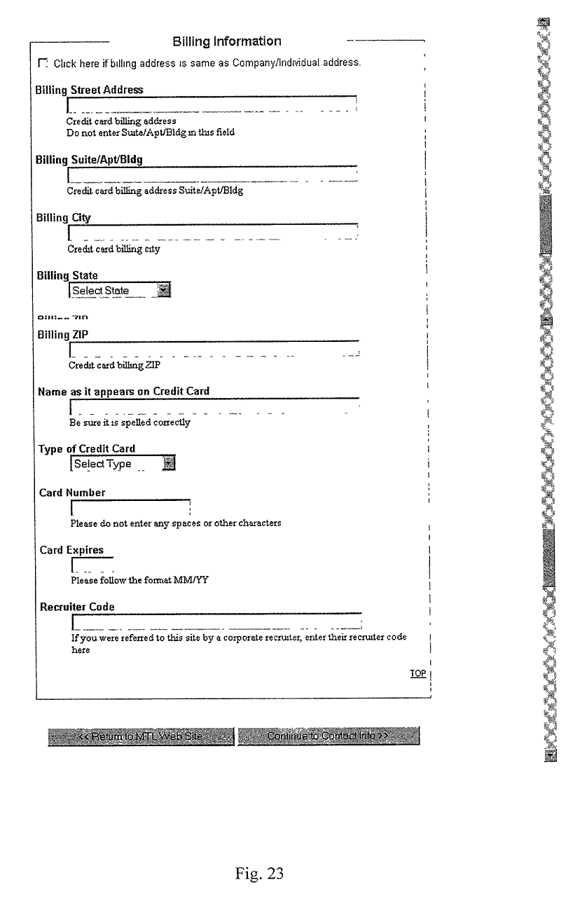

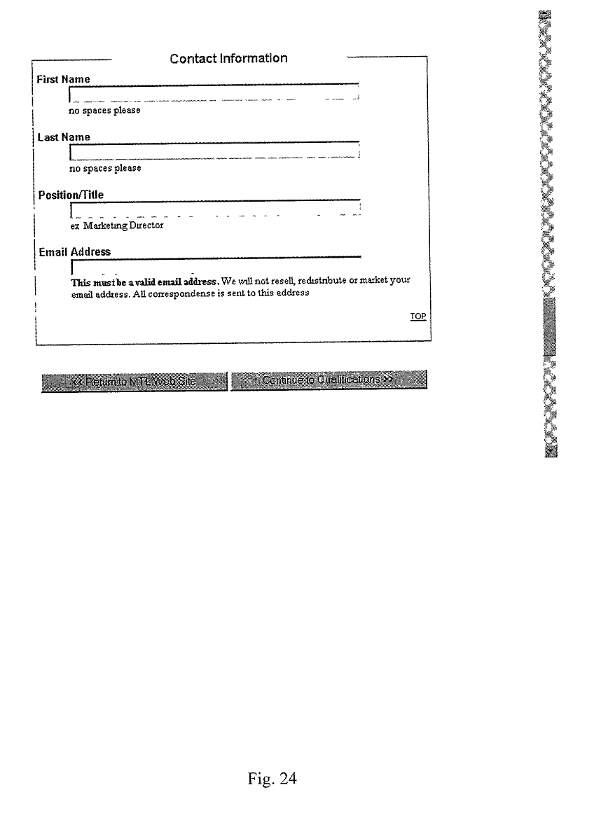

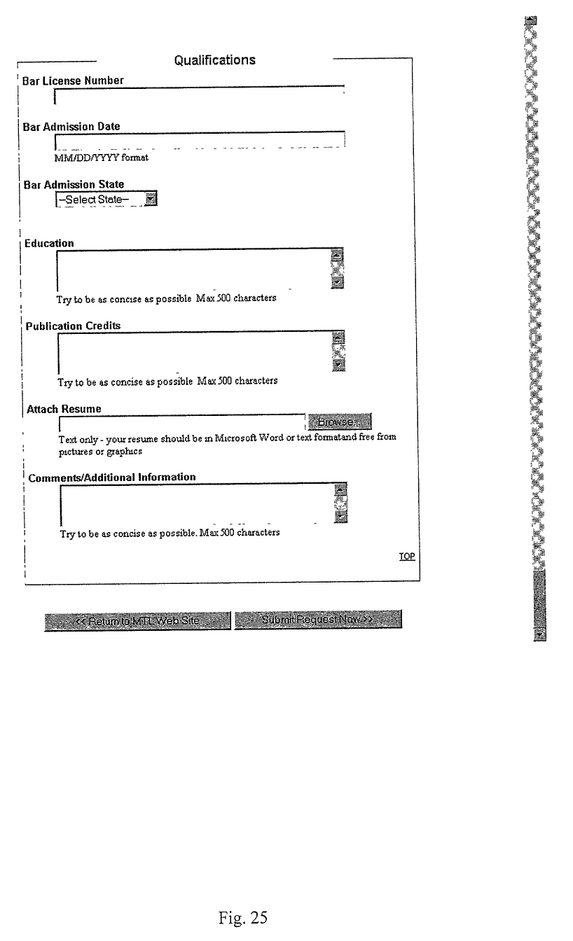

An attorney can select an adjacent link 55 for an application. Such link takes a user through a secure on-line purchasing sequence, presenting the user with an on-line Affiliate Application FIG. 21 and suggesting the applicant attach a recent resume. Templates for Application information may request company information FIG. 22, billing information FIG. 23, contact information FIG. 24, and qualifications FIG. 25. Only licensed attorney may become Affiliates and not all applicants may be approved for membership.

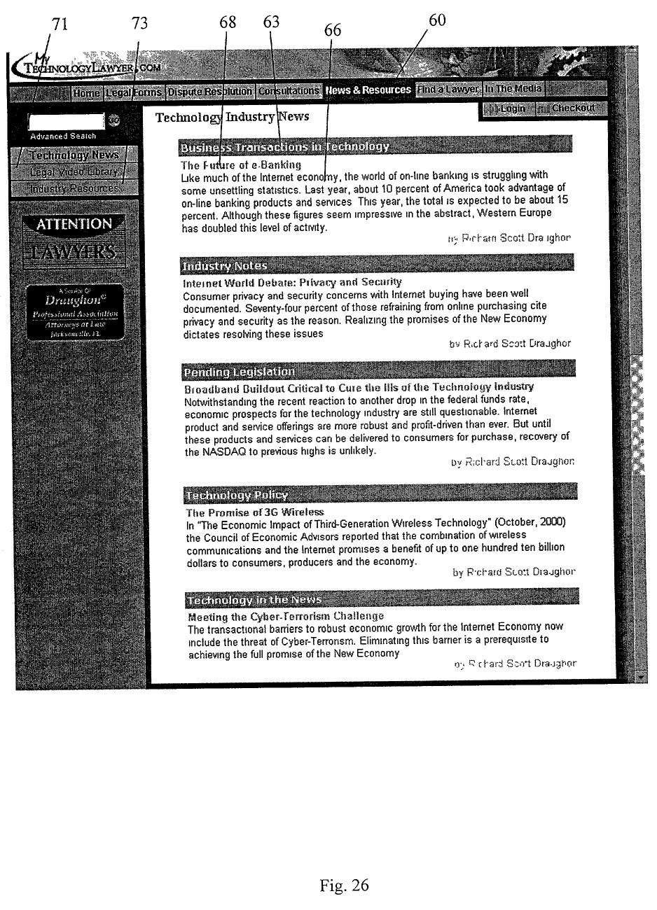

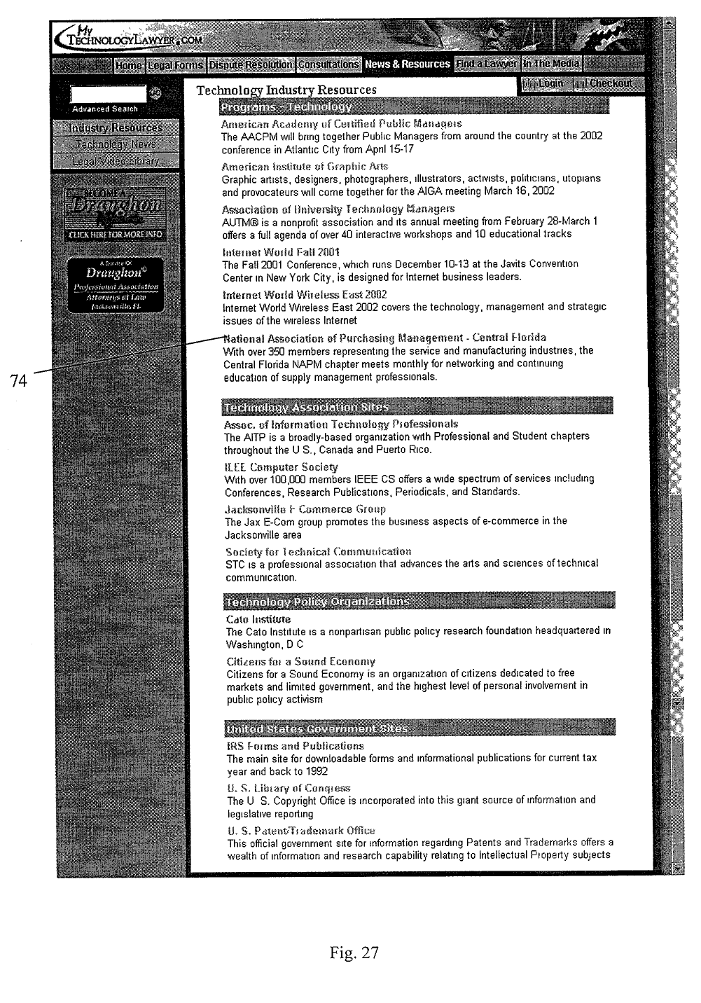

The “News & Resources” section, accessed by selecting a corresponding link such as the tab 60 shown at the top of FIG. 26, or tab 5 shown at the top of FIG. 1, includes an overview of published articles related to Technology Industry News. Each news article includes a title 63, summary 66, and link to the entire article 68. A graphical hierarchical tree facilitates navigation to the Legal Video Library 71 and additional Industry Resources 73. The Legal Video Library contains streaming video concerning various aspects of technology law as described above and in more detail in co-pending U.S. patent application Ser. No. 09/820,031 entitled System and Method for Rendering Legal Services Over the Internet, incorporated herein by reference in its entirety. A user may gain access to a variety of Technology Industry Resources, using the links, such as 74 as shown in FIG. 27.

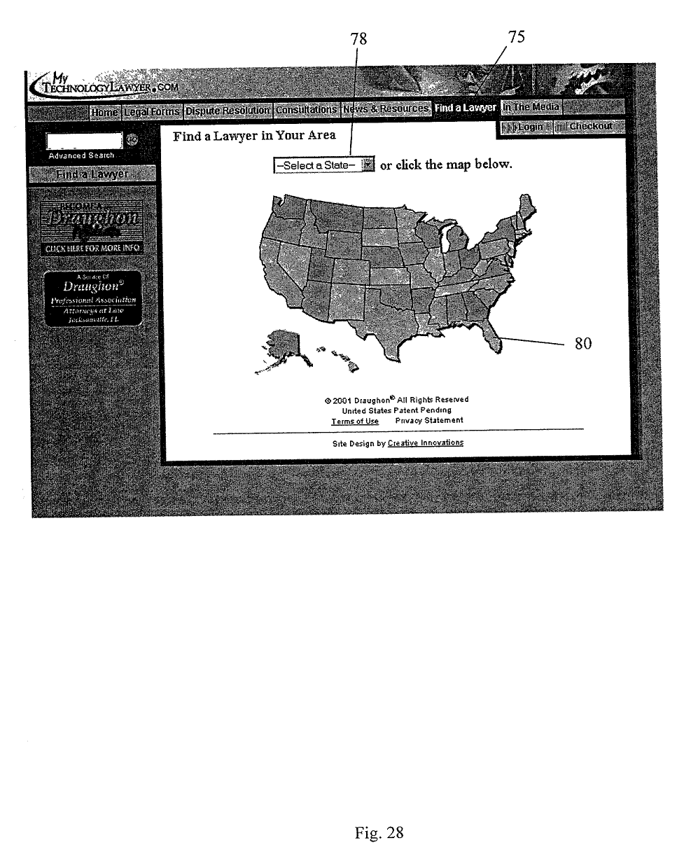

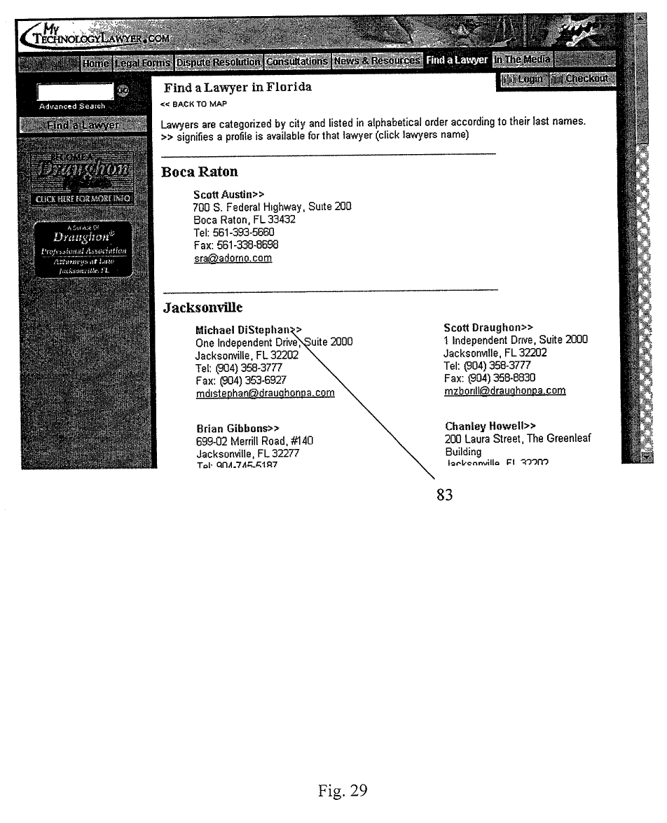

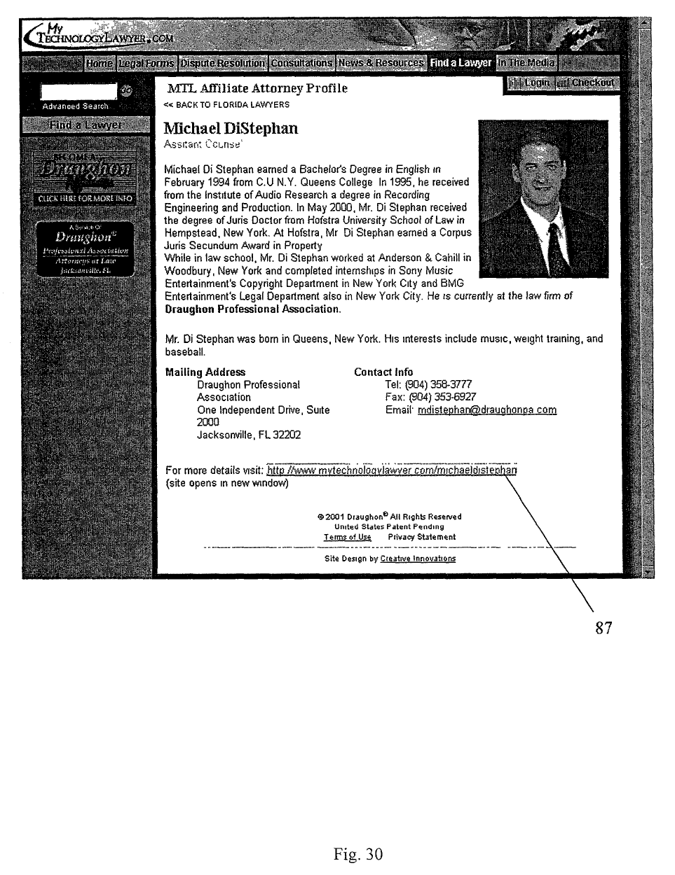

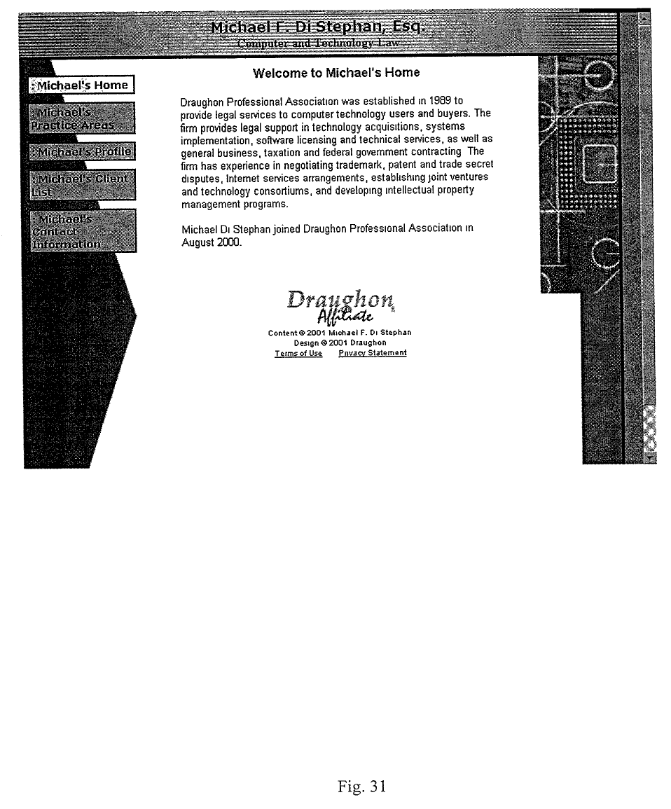

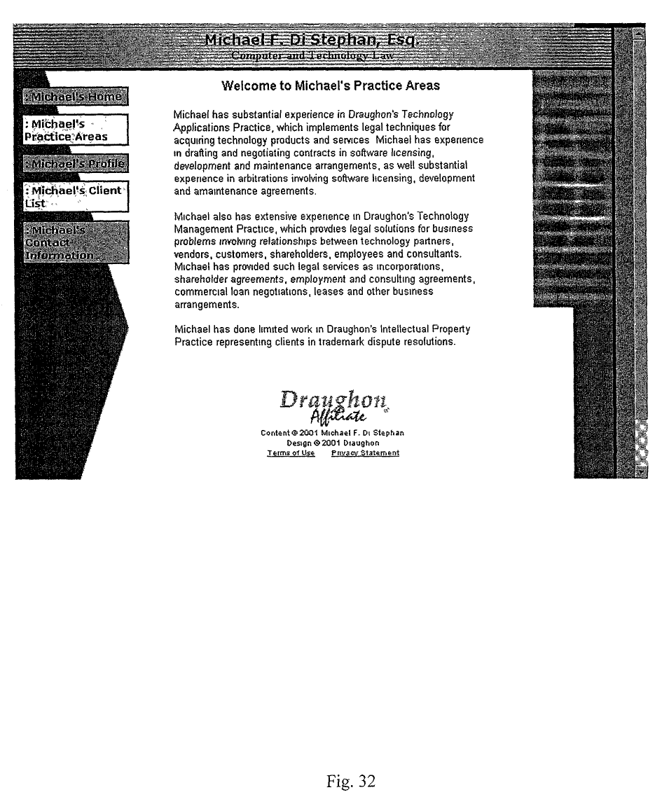

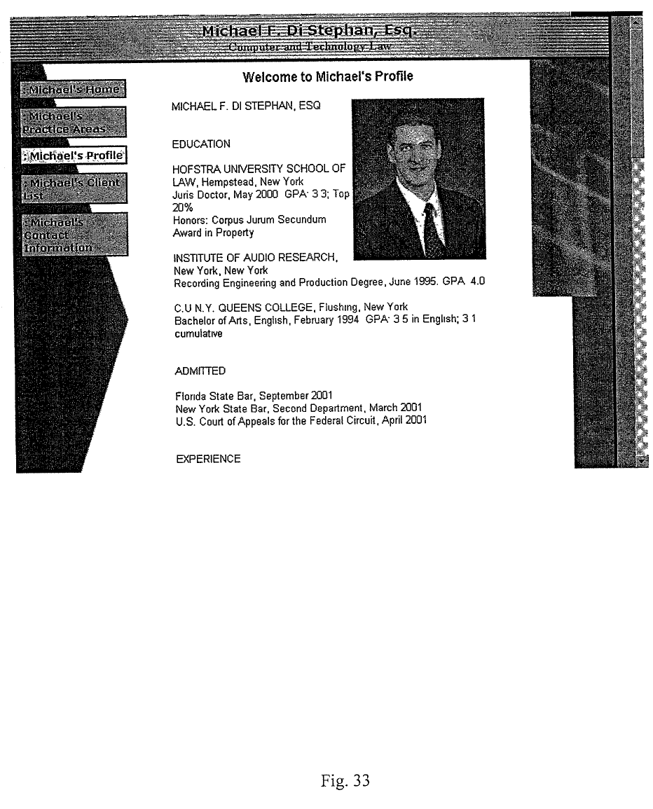

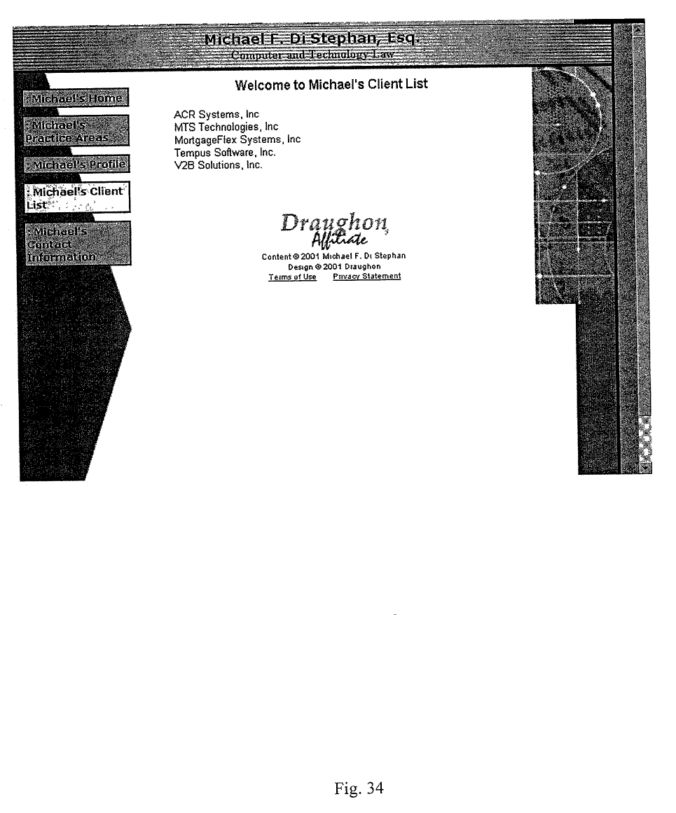

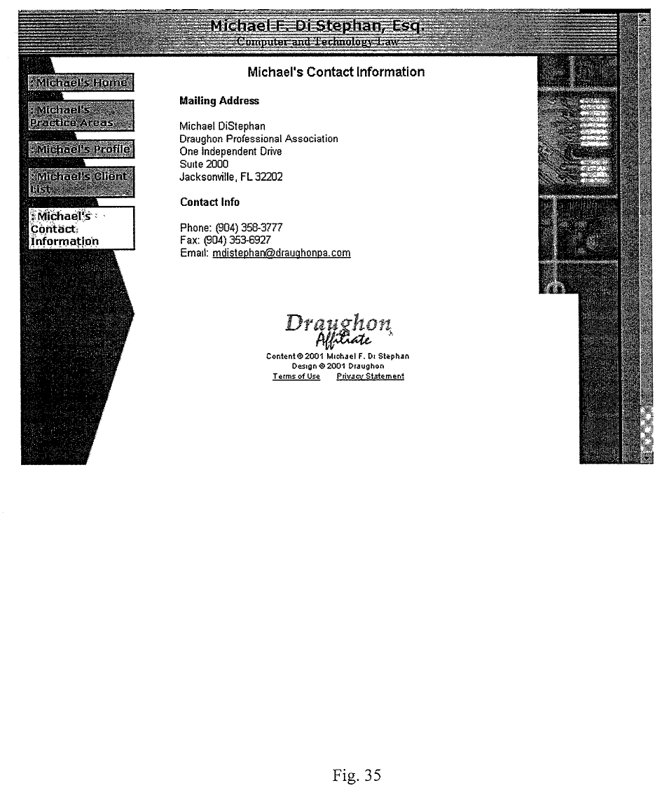

The “Find a Lawyer” section, accessed by selecting a corresponding link such as the tab 75 shown at the top of FIG. 28, or tab 6 shown at the top of FIG. 1, enables an interactive representation of the fifty United States. A menu of links 78 may provide access to the various states, as shown in FIG. 28. Alternatively, a user can click directly on the map. For example, if a user clicks on the illustration of the state of Florida 80, a listing of lawyers in Florida who are affiliated with the program is displayed, as in FIG. 29. A profile of selected attorneys can be obtained by a link associated with the attorney's name 83. FIG. 30 is a representative display of an Attorney Affiliate Profile. One of the benefits of the Affiliate Program is the ability to create a personal website (item 49, FIG. 10). A link 87 to the attorney's personal website may be provided on the Attorney Affiliate Profile page. FIGS. 31-35 provide representative sample website pages for an Attorney Affiliate.

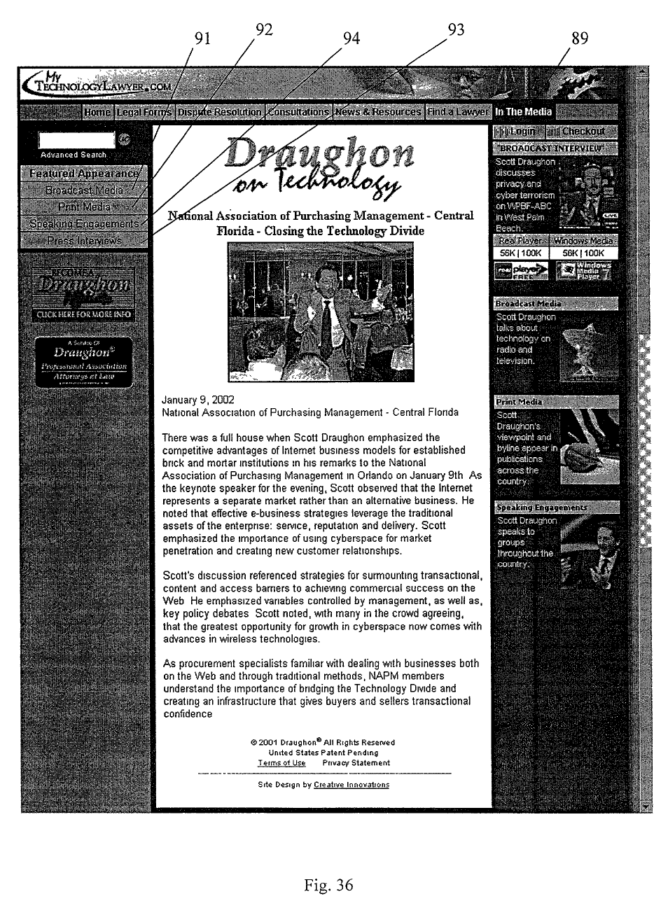

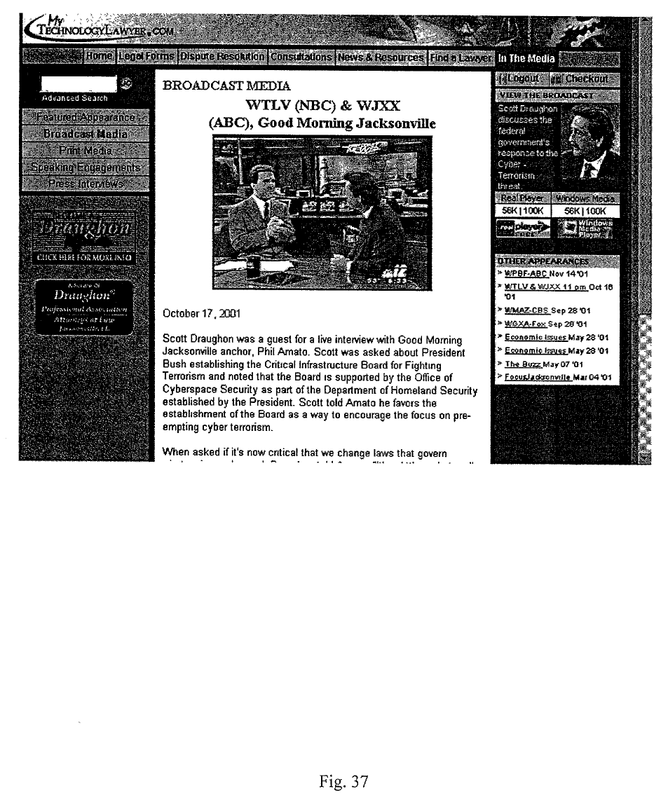

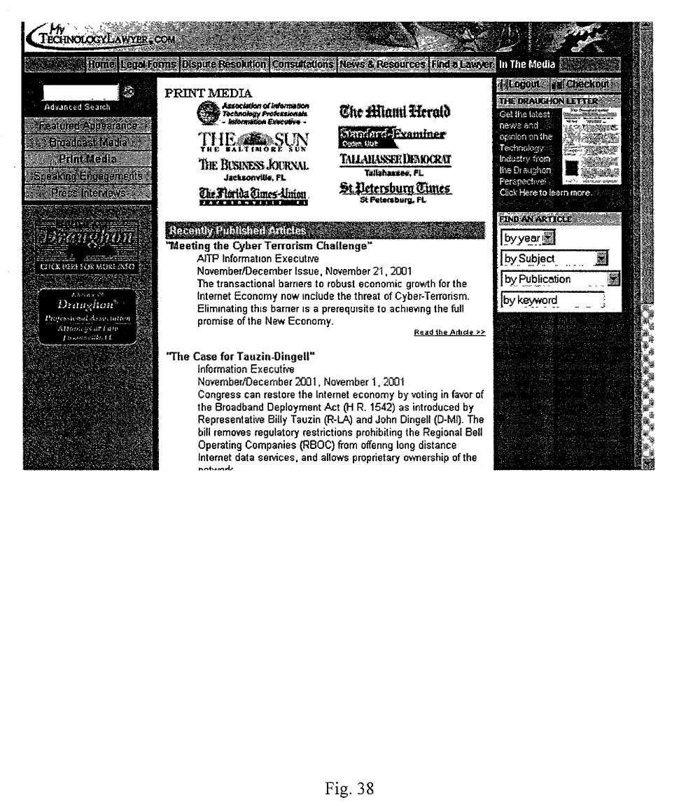

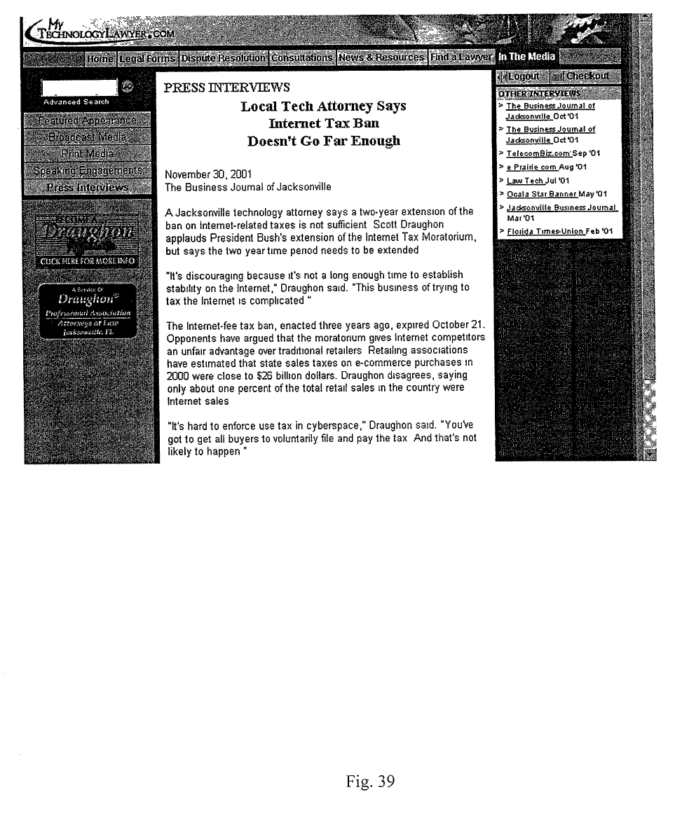

The “In The Media” section is accessed by selecting a corresponding link such as the tab 89 shown at the top of FIG. 36, or tab 7 shown at the top of FIG. 1. A user may access publications from Broadcast Media 91, Print Media 92, Press Interviews 93, and Speaking Engagements 94 by selecting a corresponding link. FIGS. 36-40 are illustrations of pages displayed by selecting Broadcast Media 91, Print Media 92, Press Interviews 93, and Speaking Engagements 94 links, respectively.

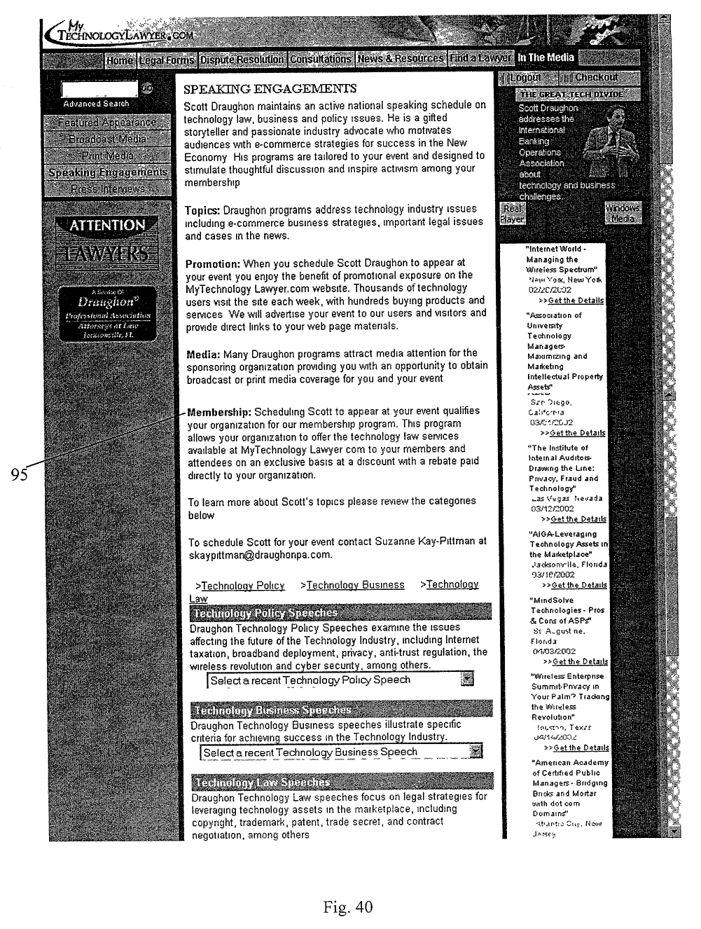

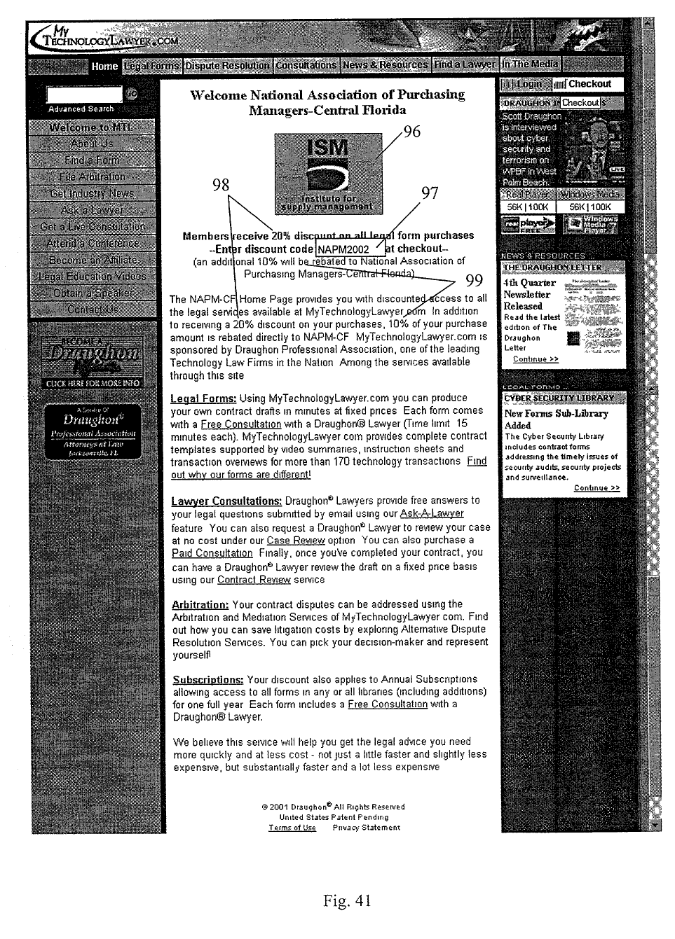

An additional feature associated with the system is the concept of membership for organizations to gain additional benefits by using the system. Referring to FIG. 40, the membership feature 95 is enabled by scheduling an identified speaker to appear at an organization's event, which qualifies such organization for the membership program. This program allows such organization to offer the technology law services available through an embodiment of the system to selected individuals on an exclusive basis at a discount with a rebate paid directly to the organization. Some of the benefits of membership may include a featured link in the Technology Industry Resources, such as item 74 (FIG. 27), publicity for a Featured Appearance, such as FIG. 36, and an exclusive Member Home page, such as FIG. 41.

As illustrated in FIG. 41, a Member Home page may be customized with an organization logo 96. Members provided limited access to such Member Home page can use a specially enabled discount code 97 to receive a predetermined discount 98 for purchases of forms and subscriptions. In some embodiments, a percentage 99 of the purchase price may be rebated to the Members' organization. For illustrative purposes, the Member discount 98 and rebate 99 are shown as 20% and 10%, respectively. Other values may be used as desired.

It will be appreciated by persons skilled in the art that numerous variations and/or modifications may be made to the invention as shown in the specific embodiments without departing from the spirit or scope of the invention as broadly described. The foregoing description of the invention refers to specific pricing options and arrangements of various sections, libraries, sub-libraries, videos, forms, Affiliate programs, Membership programs and content in the area of Technology Law, as examples of a preferred embodiment. Other areas of law may be covered without departing from the scope of the subject invention. Additionally, other pricing options, arrangements, sections, libraries, sub-libraries, videos, forms, programs, and content may be used without departing from the scope of the subject invention. The present embodiments are, therefore, to be considered in all respects as illustrative and not restrictive.

While specific values, relationships, materials and steps have been set forth for purposes of describing concepts of the invention, it should be recognized that, in the light of the above teachings, those skilled in the art can modify those specifics without departing from basic concepts and operating principles of the invention taught herein. Therefore, for purposes of determining the scope of patent protection, reference shall be made to the appended claims in combination with the above detailed description

What is claimed is:

1. A system for rendering legal services on-line, such system comprising:
a. means for providing a first set of predetermined benefits to an affiliate who subscribes for such benefits;
b. means for providing a second set of predetermined benefits to selected organizations that become a member; and
c. means for providing media publicity on-line.

2. The system according to claim 1, such system further comprising:
a. means for providing an agreement to which an affiliate must assent before such affiliate obtains such first set of predetermined benefits,
b. means for obtaining affiliate identification information before such affiliate accesses obtains such first set of predetermined benefits, and
c. means for obtaining affiliate qualification information before such affiliate obtains such first set of predetermined benefits.

3. The system according to claim 2, wherein such first set of predetermined benefits is selected from the group consisting of:
a. unlimited access to legal forms,
b. regular access to senior practitioners for practice support,
c. listing as an arbitrator/mediator for alternate dispute resolution,
d. listing in an attorney directory listing,
e. providing opportunity to publish scholarly articles,
f. providing opportunity to participate in technology policy conferences,
g. assistance in establishing local technology programs,
h. participation in peer collaboration, and
i. individual personal website.

4. The system according to claim 3, such system further comprising:
a. means for listing an affiliate in an arbitrator/mediator listing,
b. means for creating a personal website, and
c. means for listing an affiliate in a directory listing, such means including:
(1) for displaying a profile for such affiliate, and
(2) means for linking to such affiliates personal website.

5. The system according to claim 4, wherein such personal website further comprises:
a. means for creating an affiliate homepage,
b. means for creating an affiliate practice area page,
c. means for creating an affiliate biography page,
d. means for creating an affiliate client list page, and
e. means for creating an affiliate contact page.

6. The system according to claim 1, such system further comprising:
means for providing a unique homepage for selected organizations that become a member, said homepage displaying a unique code for use by members belonging to such organization.

7. The system according to claim 6, such system further comprising on-line purchasing means, such on-line purchasing means comprising one or more of the following:
a. means for purchasing a legal form on-line,
b. means for purchasing a subscription to a library on-line, and
c. means for purchasing a subscription to a sub-library on-line.

8. The system according to claim 7, wherein such second set of predetermined benefits is selected from the group consisting of:
a. focused on-line publicity;
b. predetermined discount for on-line form purchases by using such unique code,
c. predetermined discounts for on-line subscription purchases by using such unique code,
d. predetermined rebate to member organization for on-line purchases using such unique code.

9. The system according to claim 8, wherein such discount for on-line form purchases by using such unique code is a predetermined percentage of such purchase amount.

10. The system according to claim 8, wherein such discount for on-line subscription purchases by using such unique code is a predetermined percentage of such purchase amount.

11. The system according to claim 8, wherein such rebate for on-line purchases using such unique code is a predetermined percentage of such purchase amount.

12. The system according to claim 1, such system further comprising:
a. means for providing legal forms on-line;
b. on-line purchasing means, such on-line purchasing means comprising one or more of the following:
(1) means for purchasing a legal form on-line,
(2) means for purchasing a subscription to a library on-line,
(3) means for purchasing a subscription to a sub-library on-line, and
(4) means for purchasing an affiliate membership on-line;
c. means for enabling an affiliate to access such legal forms;
d. means for providing an agreement to which the affiliate must assent before such affiliate accesses any one of such legal forms;
e. means for obtaining affiliate identification information before such affiliate accesses any one of such legal forms;
f. means for obtaining affiliate qualification information before such affiliate accesses any one of such legal forms;
g. a hierarchical arrangement of libraries and sub-libraries, wherein:
(1) each library is accessible on-line, covers a legal topic and provides access to sub-libraries, and
(2) each sub-library is accessible on-line, covers an aspect of such legal topic and provides access to other sub-libraries or such legal forms;
h. means for providing instructional videos on-line for the legal topic that each library covers and for the aspect of such legal topic that each sub-library covers;
i. means for providing written information on-line for the legal topic that each library covers and for the aspect of such legal topic that each sub-library covers;
j. a library of educational videos accessible on-line concerning subject matter related to the legal forms;
k. means for listing an affiliate in an arbitrator/mediator listing;
l. means for creating a personal website;
m. means for listing an affiliate in a directory listing, such means including:
(1) for displaying a profile for such affiliate, and
(2) means for linking to such affiliates personal website.

13. The system according to claim 12, further comprising:
a. means for establishing a membership for an organization;
b. means for providing focused publicity for such member organization;
c. means for providing a unique homepage for selected organizations that become a member, said homepage displaying a unique code for use by members belonging to such organization;
d. means for providing a discount for purchase by such member using such unique code; and
e. means for providing a rebate to such member organization based on such purchase.

14. A method for rendering legal services on-line, such method comprising the steps of:
a. providing legal forms on-line;
b. providing a hierarchical arrangement of libraries and sub-libraries on-line, wherein:
(1) each library covers a legal topic and provides access to sub-libraries, and
(2) each sub-library covers an aspect of such legal topic and provides access to other sub-libraries or such legal forms;
c. providing instructional videos on-line for one or more of the following:
(1) the legal forms,
(2) the legal topic which each library covers, and
(3) the aspect of such legal topic which each sub-library covers;
d. providing written information on-line concerning one or more of the following:
(1) the legal forms,
(2) the legal topic which each library covers, and
(3) the aspect of such legal topic that each sub-library covers;
e. providing an on-line directory of affiliate attorneys;
f. providing an on-line profile of such affiliate attorneys;
g. providing a personal website for such affiliate attorneys;
h. providing unlimited access to such legal forms by such affiliate attorneys; and
i. providing predetermined benefits to such affiliate attorneys.

15. The method according to claim 14, wherein such predetermined benefits are selected from the group consisting of:
a. regular access to senior practitioners for practice support,
b. listing as an arbitrator/mediator for alternate dispute resolution,
c. providing opportunity to publish scholarly articles,
d. providing opportunity to participate in technology policy conferences,
e. assistance in establishing local technology programs, and
f. participation in peer collaboration.

16. The method according to claim 14, such method further comprising one or more of the following steps:
a. providing means for establishing a membership for an organization,
b. providing means to make available focused publicity for such member organization,
c. providing means to make available a unique homepage for such member organization, such homepage displaying a unique code for use by members belonging to such organization,
d. providing a discount for purchases by such member using such unique code, and
e. providing a rebate to such member organization based on such purchase.

17. The method according to claim 14, such method further comprising the steps of:
a. providing information concerning technology related industry news;
b. providing information concerning available technology related resources; and
c. providing information concerning media exposure of technology related issues, such media exposure being selected from the group consisting of:
(1) broadcast media,
(2) print media,
(3) speaking engagements, and
(4) press interviews.
